(19) United States
(12) Patent Application Publication
(10) Pub. No.: US 2015/0138222 A1
(43) Pub. Date: May 21, 2015

(54) IMAGE PROCESSING DEVICE AND MULTI-PROJECTION SYSTEM

(71) Applicant: CANON KABUSHIKI KAISHA, Tokyo (JP)

(72) Inventors: Kazuhiro Imaizumi, Saitama-shi (JP); Naoki Kojima, Yokohama-shi (JP); Toshiyuki Ishii, Tokyo (JP); Wataru Suzuki, Tokorozawa-shi (JP); Futoshi Hachimura, Kawasaki-shi (JP); Akihiro Takamura, Kokubunji-shi (JP); Eisaku Tatsumi, Kawasaki-shi (JP)

(21) Appl. No.: 14/538,675

(22) Filed: Nov. 11, 2014

(30) Foreign Application Priority Data
Nov. 15, 2013 (JP) 2013-237188

(51) Int. Cl. G06F 3/14; G09G 5/10; G03B 21/00; G09G 3/00

(52) U.S. Cl. CPC G06F 3/1423; G09G 3/002; G09G 5/10; G03B 21/00; G09G 3/006; G09G 2320/0626; G09G 2320/0693
USPC 345/589

(57) ABSTRACT

An image processing device, for making a plurality of projectors project an image based on an input image signal such that a part of a projection region overlaps, includes an acquiring unit and a generating unit. The acquiring unit acquires distribution information on distribution of a luminance of a displayed image when the projector projects the image based on an image signal in which a pixel value is constant. The generating unit generates an image signal for each projection of the plurality of projectors, by correcting the input image signal by using each distribution information of the plurality of projectors.

### BACKGROUND OF THE INVENTION

1. Field of the Invention

The present invention relates to an image processing device, a multi-projection system, an image processing method, an image projection method, and a program, preferably used for, in particular, multi-projection in which divided images are projected by a plurality of projectors simultaneously as one image.

2. Description of the Related Art

In the related art, a multi-projection system has been known in which each of two or more projectors used simultaneously projects an image, and projects these images as a combined image on a screen. When the image is projected on the screen from each projector so that a part of a projection surface overlaps, luminance of a region (overlapping region), to which a plurality of projectors projects images in an overlapping manner, becomes high compared with the luminance of the region to which a single projector projects an image. This phenomenon also occurs when each projector projects an image of a monochromatic black color, which is the darkest color expressed by the projector. Many projectors have employed a liquid crystal system or a DLP system, and project an image by the method in which light from the lamp is controlled by an optical element. Therefore, the perfect black cannot be expressed even when the black image is projected. As a result, the luminance of the overlapping region becomes high.

The following method has been known as a method to correct the luminance of the screen to become constant even when the black image is projected. In this method, the luminance of other projection regions is adjusted to the luminance of the brightest projection region of all the projection regions in a model, in which the luminance of the whole projection region of each projector is the luminance at the center of an optical axis of each projector. In this model, for example, when the images are projected by four projectors to form a “cross inside a square”, a visual image of the brightness of the projection screen before correction can be expressed as shown in FIG. 9A. The overlapping region, to which the more projectors project images in an overlapping manner, has the higher luminance.

For example, in a coordinate system having the upper left on the projection surface as a point of origin, a luminance level where y=a and y=b has an result as shown in FIG. 9B. In this model, the luminance of the overlapping region near the center, to which four projectors project images in an overlapping manner, is the highest. A correction value of each pixel is obtained by the difference between a luminance value of each pixel on the projection region and the highest luminance value. Then, the correction value is added to each pixel value corresponding to the image projected by the projector. Therefore, the luminance of the whole projection region becomes the highest luminance of the whole region, to make the luminance of the whole projection region constant. As a result, the brightness of the whole projection screen becomes constant as shown in FIG. 9C. As to the luminance level where y=a and y=b, the luminance distribution has a constant value as shown in FIG. 9D.

However, in this method, black floating has occurred in the whole projection region depending on the luminance of the overlapping region to which the plurality of projectors projects images in most overlapping manner. That is, when the images are projected to four regions to form a “cross inside a square”, the black floating occurs four times compared with the region to which a single projector projects an image. When the projector projects an image in a dark space, the black floating especially becomes conspicuous.

For example, the following method is given as a method to correct black while reducing the black floating. In the method described in Japanese Patent Application Laid-Open No. 2008-288714, a light shielding mask with a transmission window of a predetermined shape is arranged between a projection lens of each projector and the projection surface. In this method, the luminance of the overlapping region is corrected by using a gradation effect (optical gradation), which is provided when the light each projector is projecting strikes the shielding mask. Furthermore, in the method described in Japanese Patent Application Laid-Open No. 2008-288714, the projection surface is photographed using a camera, in case the luminance cannot be corrected by the gradation effect. The correction amount is determined by the difference in pixel between the luminance distribution of the projection region to be targeted and the luminance distribution of the photographed projection region. Then, the luminance is corrected by adding the correction amount to the pixel value of an output image of the projector.

According to this method, when the projector is strictly arranged, the luminance distribution where y=a in FIG. 9A becomes the distribution as shown in FIG. 10. Then, the luminance level of the overlapping region is the same as that of the region to which a single projector projects an image. In this manner, the luminance of the whole projection region of each projector is made constant while reducing the black floating.

In the method described in Japanese Patent Application Laid-Open No. 2003-315914, each projector projects an image, while being controlled, so that the plurality of projectors does not project images simultaneously on the overlapping region, and each projection region is photographed by the camera. Then, the luminance or the color for each pixel is corrected by image processing based on a photographed image. In the method described in Japanese Patent Application Laid-Open No. 2003-315914, it is possible to reduce the black floating, since the correction to make the luminance of the whole projection region constant can be made in consideration of decrease in the amount of peripheral brightness. Here, the decrease in the amount of peripheral brightness is a property, in which the luminance of the projection position apart from the center of the optical axis on the projection region, decreases compared with the luminance at the center of the optical axis due to aberration, when the image is projected by using one projector.

For example, as shown in FIG. 11, when the monochromatic image is projected on the screen, the luminance decreases as apart from the center of the optical axis of the projection region, in the luminance distribution where y=a in the coordinate system having the upper left on the screen as a point of origin. When the correction is made by this method, the luminance distributions of the projection region before/after correction where y=a shown in FIG. 9A become the distributions as shown in FIGS. 12A and 12B respectively. In this manner, the luminance of the whole projection region of each projector can be made constant while reducing the black floating.

However, in the methods described in Japanese Patent Application Laid-Open Nos. 2008-288714 and 2003-315914, there is a problem that it requires significant cost, since the projection surface is photographed by the camera and the luminance is corrected by using the photographed image. It is possible to reduce the decrease in the amount of peripheral brightness by narrowing an aperture of the projection lens, thereby darkening the center of the optical axis, in order to reduce the decrease in the amount of peripheral brightness. However, in the methods of the related art, when the luminance distribution is tried to be constant by multi-projection in a state where the aperture of the projection lens is narrowed, the black floating becomes conspicuous since the luminance of at the center of the optical axis reduces.

### SUMMARY OF THE INVENTION

According to an aspect of the present invention, an image processing device, for making a plurality of projectors project an image based on an input image signal such that a part of a projection region overlaps, includes an acquiring unit configured to acquire distribution information on distribution of a luminance of a displayed image when the projector projects the image based on an image signal in which a pixel value is constant, and a generating unit configured to generate an image signal for each projection of the plurality of projectors, by correcting the input image signal by using each distribution information of the plurality of projectors.

Further features of the present invention will become apparent from the following description of exemplary embodiments (with reference to the attached drawings).

### BRIEF DESCRIPTION OF THE DRAWINGS

FIG. 1 is a view illustrating an example of a configuration of a multi-projection system of an embodiment.

FIG. 2 is a block diagram illustrating an example of internal configurations of an image processing device and a projector of the embodiment.

FIGS. 3A and 3B are diagrams illustrating a position on a projection surface and its luminance distribution of the embodiment.

FIG. 4 is a diagram illustrating distribution of a correction value in each position on the projection surface of the embodiment.

FIG. 5 is a diagram illustrating the luminance distribution after correction of the embodiment.

FIG. 6 is a flowchart illustrating an example of a processing procedure of the image processing device of the embodiment.

FIG. 7 is a block diagram illustrating an example of internal configurations of an image processing device and a projector of an embodiment.

FIG. 8 is a flowchart illustrating an example of a processing procedure of a multi-projection system of the embodiment.

FIGS. 9A to 9D are diagrams for explanation of the luminance distribution of a projection screen before/after correction of the embodiment.

FIG. 10 is a diagram illustrating an example of the luminance distribution by a correction method of the related art.

FIG. 11 is a diagram for explanation of the luminance distribution including decrease in the amount of peripheral brightness.

FIGS. 12A and 12B are diagrams for explanation of the luminance distribution before/after correction in consideration of the decrease in the amount of peripheral brightness.

### DESCRIPTION OF THE EMBODIMENTS

### First Embodiment

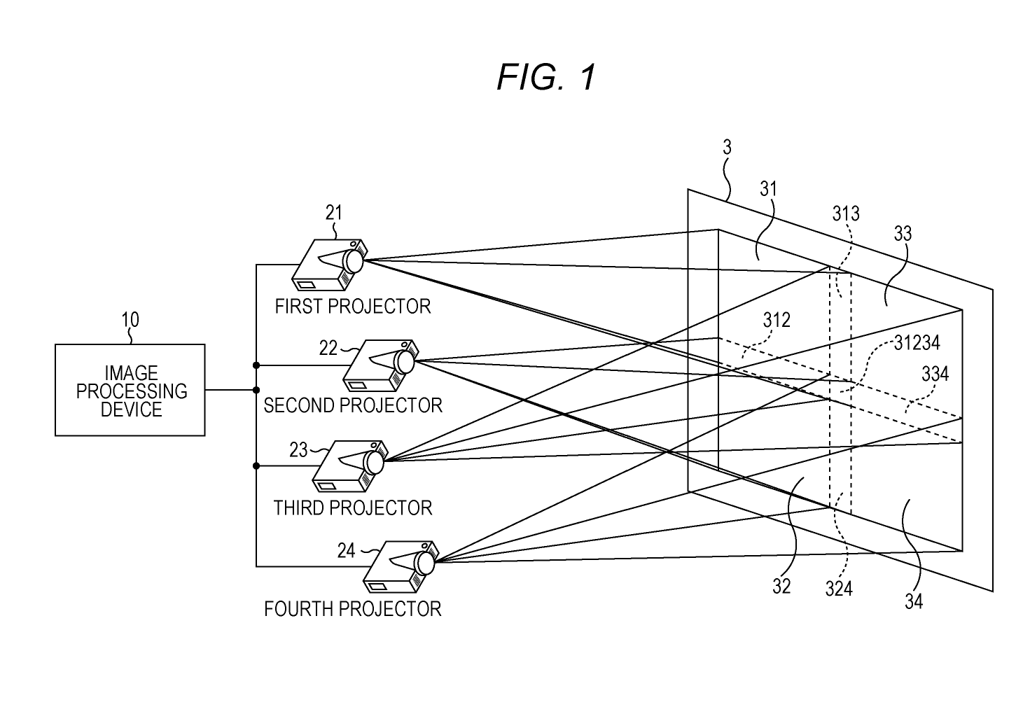

Hereinafter, embodiments of the present invention will be described with reference to the drawings. In the present embodiment, an example will be described in which four projectors project images simultaneously to form a “cross inside a square” as shown in FIG. 1, so that the effect is shown more noticeably.

FIG. 1 is a view illustrating an example of the configuration of a multi-projection system according to the present embodiment. In the multi-projection system shown in FIG. 1, four projectors (first to fourth projectors 21 to 24) are arranged so that a part of a projection region is displayed on a screen 3 in the “cross inside a square” shape in an overlapping manner.

The projection positions on the screen 3 by these projectors are as follows: upper left for the first projector 21; lower left for the second projector 22; upper right for the third projector 23; and lower right for the fourth projector 24. Each of the first to fourth projectors 21 to 24 is connected to an image processing device 10 and projects the image acquired from the image processing device 10.

In the present embodiment, a projection surface to which the multi-projection system projects an image, is classified into the following regions according to overlap. Regions 31 to 34 are the regions, to which the first to fourth projectors 21 to 24 project images, respectively. A region 312 is the region where the first and second projectors 21 and 22 project images in an overlapping manner, and a region 313 is the region where the first and third projectors 21 and 23 project images in an overlapping manner. Similarly, a region 324 is the region where the second and fourth projectors 22 and 24 project images in an overlapping manner, and a region 334 is the region where the third and fourth projectors 23 and 24 project images in an overlapping manner. A region 31234 is the region where the first to fourth projectors 21 to 24 project images in an overlapping manner.

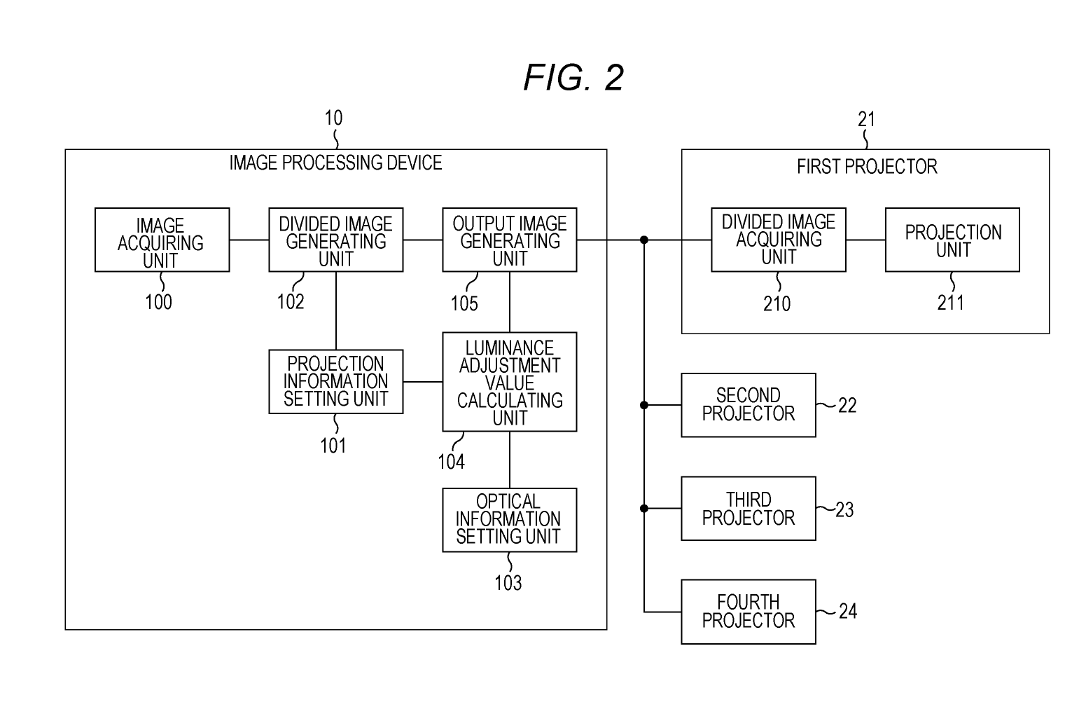

FIG. 2 is a block diagram illustrating an example of internal configurations of the image processing device 10 and the first projector 21 shown in FIG. 1. Hereinafter, the main parts of the image processing device 10 and the first projector 21 will be described. Since the internal configurations of the second to fourth projectors 22 to 24 are similar to that of the first projector 21, the description thereof will be omitted.

The image processing device 10 divides the image projected by the multi-projection system, performs correction processing on each divided image according to the luminance distribution so that each divided image can be projected by each projector, and sends the corrected image to each projector. Hereinafter, the detailed internal configuration of the image processing device 10 will be described.

An image acquiring unit 100 acquires an image signal from an external device through an interface such as a DVI or an HDMI (registered trademark) and the image signal is retained in a buffer (not shown). Alternatively, the image processing device 10 may include a recording device, etc. inside thereof, reads the image from this recording device, and retains the image in the buffer.

A projection information setting unit 101 retains positional information of the projection region on the screen by each projector. This positional information of the projection region is acquired and retained, for example, by inputting a numerical value actually measured by a user via a keyboard, which is connected to the image processing device 10. A divided image generating unit 102 divides the image acquired by the image acquiring unit 100 into the divided image of each region output by each projector, based on the positional information of the projection region of each projector, retained by the projection information setting unit 101.

An optical information setting unit 103 retains information of the luminance value of each pixel in a case where each projector simultaneously projects the image of a predetermined color (black in the present embodiment) to the projection region on the screen. The distribution of the luminance values is based on the optical characteristic attributed to a lens or a lamp of each projector, and the value preliminarily recorded at factory shipment, etc. can be employed for the distribution of the luminance values. By identifying the distribution information of luminance by the optical characteristic preliminarily recorded when manufacturing a product, the user's labor to perform operation reduces. The image processing device 10 may acquire the distribution information of the luminance value based on the optical characteristic of each projector from an information providing server, which is connected via a network. In this case, the information providing server stores product identification information of each projector and information on the distribution of the luminance values in association with each other. Then, the information providing server provides information on the distribution of the luminance values in response to an inquiry from the image processing device 10 and the projector.

The information on the distribution of the luminance values can be measured each time one or more projectors project an image. The information on the distribution of the luminance values may also be measured at every predetermined time. In this case, a luminance sensor is connected to the image processing device 10. With this configuration, for example, even when the optical characteristic at factory shipment changes for some reason, luminance correction is possible based on the optical characteristic after change. The luminance value of the projection region may be recorded in the buffer by using the known information compression technology such as ZIP compression. In the following description, the luminance value indicates a value in a case where a black image is projected.

A luminance adjustment value calculating unit 104 calculates a correction value of each pixel of the divided image projected by each projector, based on the positional information retained by the projection information setting unit 101 and the information of the luminance value retained by the optical information setting unit 103. An output image generating unit 105 corrects the divided image, which is divided by the divided image generating unit 102, based on the correction value of each pixel of each projector calculated by the luminance adjustment value calculating unit 104. The output image generating unit 105 generates the divided image for the projection and sends the divided image to each projector. For example, in a case of a model in which each pixel of the divided image is in 8-bit format of RGB and brightness is changed in each subpixel of RGB at the same rate, the correction is made as follows. That is, the luminance of the divided image is corrected by adding the correction value to each subpixel value of RGB of the divided image of each projector. The first to fourth projectors 21 to 24 acquire the projection image from the image processing device 10 and project it on the screen.

Hereinafter, functions of the first projector 21 will be described.

A divided image acquiring unit 210 receives the divided image (projection image) from the output image generating unit 105. A projection unit 211 sets a color value for each pixel of the projection image received by the divided image acquiring unit 210, and projects an image by a liquid crystal display device (not shown), etc.

Hereinafter, the luminance distribution and the correction in consideration of the optical characteristic by multi-projection of the above four projectors will be described. In the present embodiment, the projection region is expressed by using coordinates of four corners on a projection surface. The point of origin of the coordinate is, for example, set at the upper left end of the screen or at the upper left end of the projection region on the screen of the first projector 21, which projects an image to the upper left among the projectors that project an image using multi-projection.

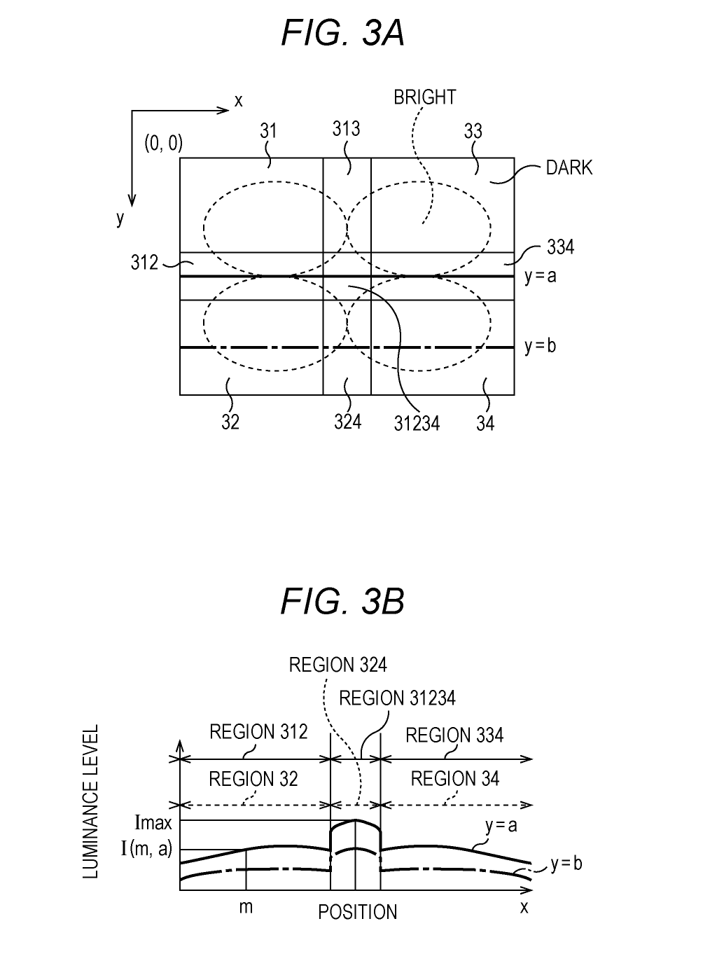

FIGS. 3A and 3B are diagrams illustrating the position on the projection surface and its luminance distribution. In FIG. 3A, the optical characteristic, that is, the decrease in the amount of peripheral brightness of each projector, has been taken into consideration. When the four projectors project images simultaneously to form a “cross inside a square”, the luminance distribution is as follows. For example, the projection region of the first projector 21 includes the region obtained by combining the regions 31, 312, 313, and 31234. The center part of the combined region is bright, and the peripheral part thereof is dark since the luminance decreases as the optical characteristic. In this manner, the luminance distribution of each projector is symmetric to the center of the projection region, and each projector has the equivalent characteristic. Therefore, as a whole, the distribution characteristic is symmetric. FIG. 3B shows the luminance distribution where y=a and y=b in a coordinate system having the upper left on the projection surface in FIG. 3A as a point of origin.

Hereinafter, a method of calculating the luminance correction value by the luminance adjustment value calculating unit 104 will be described. First, the luminance adjustment value calculating unit 104 classifies the projection region as shown in FIG. 1, based on the positional information of the projection region of each projector, retained by the projection information setting unit 101. Next, the luminance adjustment value calculating unit 104 obtains a luminance value I (x, y) of each pixel for each region from the distribution of the luminance values of all the projection regions retained by the optical information setting unit 103. Here, x and y respectively represent the x and y coordinates of each pixel within the projection region.

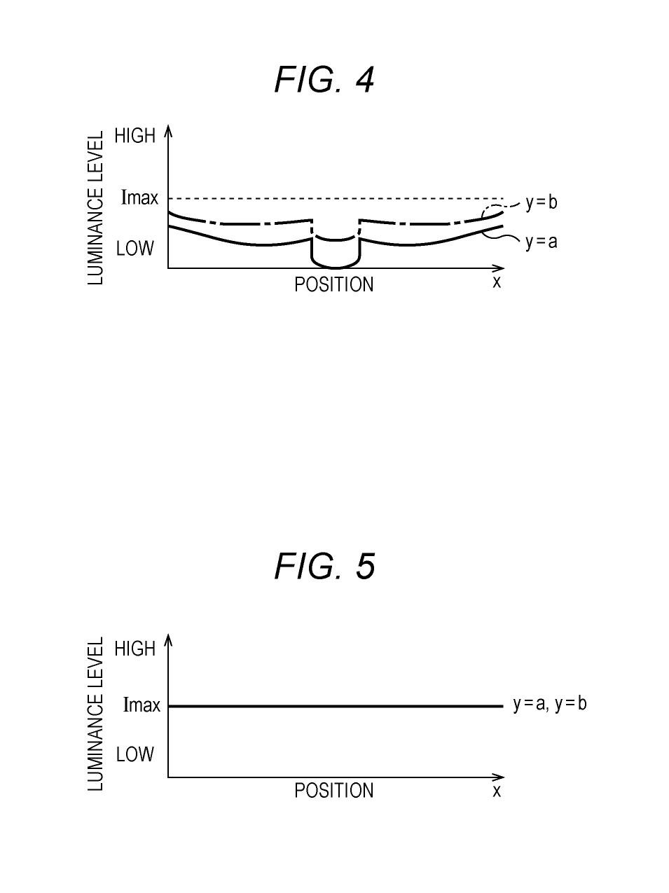

Next, the luminance adjustment value calculating unit 104 obtains a maximum luminance value Iₘₐₓ of the whole projection region from the calculated luminance value I (x, y) of each pixel of each projection region. As shown in FIG. 3B, this maximum luminance value Iₘₐₓ is set as the total amount of the black floating. Next, the luminance adjustment value calculating unit 104 obtains a difference for each pixel between the maximum luminance value Iₘₐₓ and the luminance value I (x, y) of each pixel as the luminance correction value of all projection regions. In FIG. 4, the distribution of the correction values where y=a and y=b calculated by the luminance adjustment value calculating unit 104 is shown.

Moreover, in the regions 312, 313, 324, 334, and 31234, for each projector projecting an image, the correction value of each pixel of each projector is obtained so that the sum of the correction values corresponds to the correction value. The correction value of each projector in the overlapping region may be merely distributed by ½ or ¼, or calculated based on a table or a gradation function. A ratio of correction for each coordinate within the overlapping region is described in the table. The output image generating unit 105 corrects by adding this correction value to each pixel of the divided image of each projector. FIG. 5 shows the luminance distribution when this correction value is added. As shown in FIG. 5, after correction, the luminance on the whole screen becomes constant and luminance unevenness is corrected.

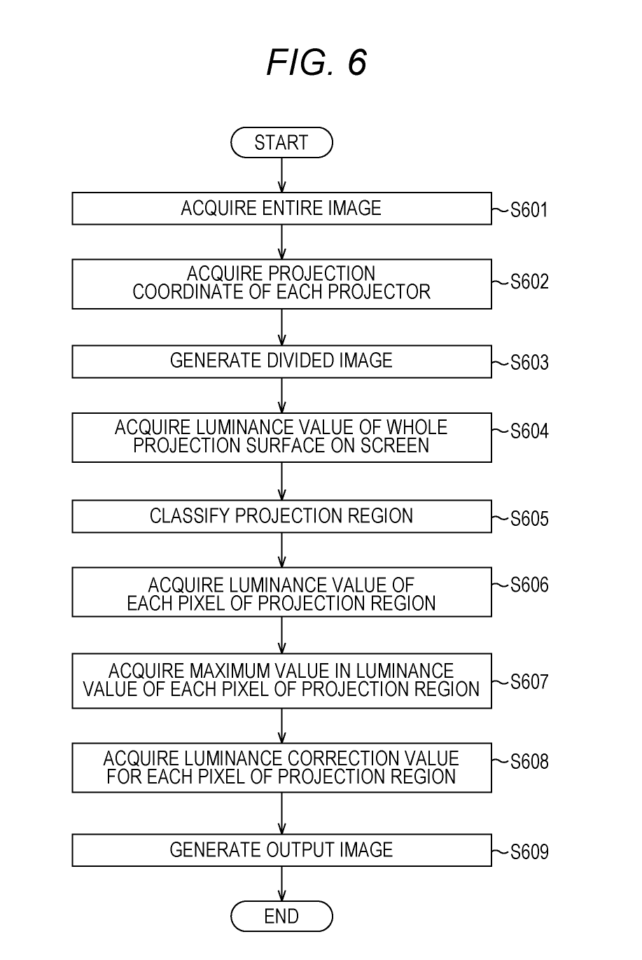

FIG. 6 is a flowchart illustrating an example of a processing procedure for generating the projection image by the image processing device 10.

First, in Step S601, the image acquiring unit 100 acquires an entire image projected by the multi-projection system. Then, in Step S602, the projection information setting unit 101 acquires the positional information of the projection region of each projector, when each projector included in the multi-projection system projects an image on the screen.

Subsequently, in Step S603, the divided image generating unit 102 extracts and generates, from the entire image, the divided image to be projected by each projector, based on the size of the entire image and the position of the projection region of each projector which the projection information setting unit 101 has acquired. The information on the size of the entire image is acquired from the attribute information, etc. of the entire image acquired. Then, in Step S604, the luminance adjustment value calculating unit 104 acquires, from the optical information setting unit 103, the information of the luminance value of all projection regions to which the multi-projection system projects an image.

As described above, the optical information setting unit 103 retains the information on the distribution of the luminance values, when each of the plurality of projectors executing multi-projection projects the image of predetermined color (for example, black). The optical information setting unit 103 can retain the information on the distribution of the luminance values corresponding to optical information, which is preliminarily set at factory shipment, etc. The optical information setting unit 103 can also measure the distribution of the luminance values each time the projector projects an image, and retain the measurement result.

Moreover, the optical information setting unit 103 can acquire and retain the information on the distribution of the luminance values by inquiring of the information providing server, which is connected via the network.

Next, in Step S605, the luminance adjustment value calculating unit 104 classifies all projection regions according to the degree of overlap on the projection surface on the screen, when each projector projects an image on the screen. For example, all projection regions are classified into each region shown in FIG. 1. Then, in Step S606, the luminance adjustment value calculating unit 104 obtains the luminance value I (x, y) of each pixel within each projection region from the information of the luminance value of all projection regions acquired in Step S604.

Next, in Step S607, the luminance adjustment value calculating unit 104 calculates the maximum luminance value Iₘₐₓ from the luminance value I (x, y) of each projection region. Then, in Step S608, the luminance adjustment value calculating unit 104 calculates the luminance correction value of each pixel of all projection regions by the difference between the maximum luminance value Iₘₐₓ and the luminance value I (x, y) of each pixel. In the overlapping region, for each projector projecting an image, the correction value is adjusted so that the sum of the correction value of each projector matches the correction value calculated by the luminance adjustment value calculating unit 104.

The image processing device 10 of the present embodiment can also calculate the correction amount of the luminance value by using the information on the optical characteristic of each projector, in addition to the difference between the maximum luminance value Iₘₐₓ and the luminance value I (x, y) of each pixel. For example, in a case where the difference in the luminance value between the center part and the peripheral part is large (attenuation of the luminance is large) in the projector 21 when the black image is projected, and the difference in the luminance value between the center part and the peripheral part is small (attenuation of the luminance is small) in the projector 23, the correction amount is determined as follows. That is, the luminance adjustment value calculating unit 104 can determine the correction amount of the luminance value, so that the correction amount of the luminance value for the pixel with a predetermined luminance value in the projection region of the projector 23 is smaller than the correction amount of the luminance value for the pixel with the predetermined luminance value in the projection region of the projector 21.

Next, in Step S609, the output image generating unit 105 acquires the divided image from the divided image generating unit 102, and acquires the correction value from the luminance adjustment value calculating unit 104. Then, the output image generating unit 105 generates the projection image projected by the projector by adding the correction value to the divided image of each projector.

As described above, according to the present embodiment, the image can be projected so that the luminance of the whole projection region on the screen becomes constant as shown in FIG. 5, by causing the divided image, which has been corrected in the procedure shown in FIG. 6, to be projected by each projector. Although the present embodiment describes the case in which the four projectors project images to form a “cross inside a square”, it is applicable to a case in which two projectors are used to project images to form a “square 8”. The present embodiment is also applicable to a case in which more than four projectors are used to project images in an overlapping manner to make a parallel or perpendicular positional relation on the screen.

### Second Embodiment

Hereinafter, a second embodiment of the present invention will be described with reference to the drawings.

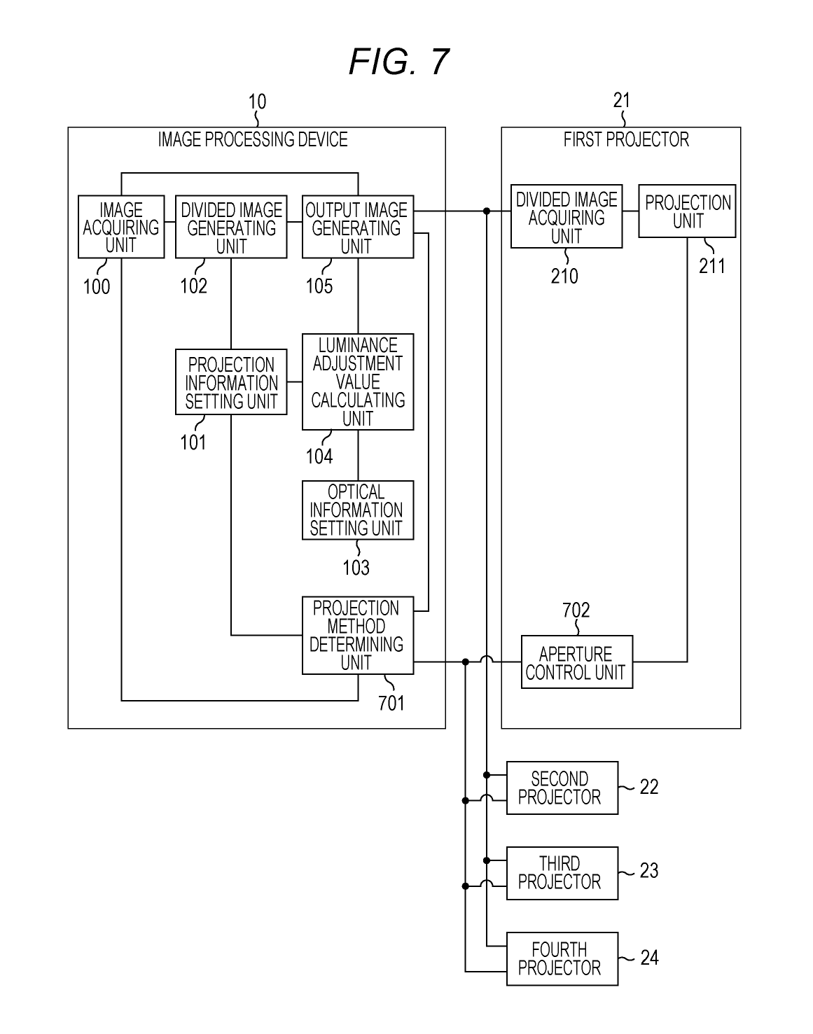

FIG. 7 is a block diagram illustrating an example of internal configurations of an image processing device 10 and a first projector 21 according to the present embodiment. A configuration of a multi-projection system according to the present embodiment is similar to FIG. 1. Since the internal configurations of second to fourth projectors 22 to 24 are similar to that of the first projector 21, the description thereof will be omitted. For the configurations shown in FIG. 7, the same reference numerals are given to the same configurations as those shown in FIG. 2, and the description of the configurations will be omitted since the functions are similar.

A projection method determining unit 701 determines whether a projection method is the projection by a single projector or simultaneous projection (multi-projection) by a plurality of projectors, based on the information retained by a projection information setting unit 101. Then, when it is determined that the projection method is the simultaneous projection by the plurality of projectors, a control signal to open an aperture of a projection lens of the corresponding projector is sent to the projector. Specifically, the control signal is sent to the projector via a communication path such as an RS-232C serial cable or a USB cable, which connects the image processing device 10 and the projector.

An aperture control unit 702 controls a projection unit 211 to open the aperture of the projection lens of the projection unit 211 when the control signal to open the aperture of the projection lens is received from the image processing device 10. As a result, the projection unit 211 opens the aperture of the projection lens.

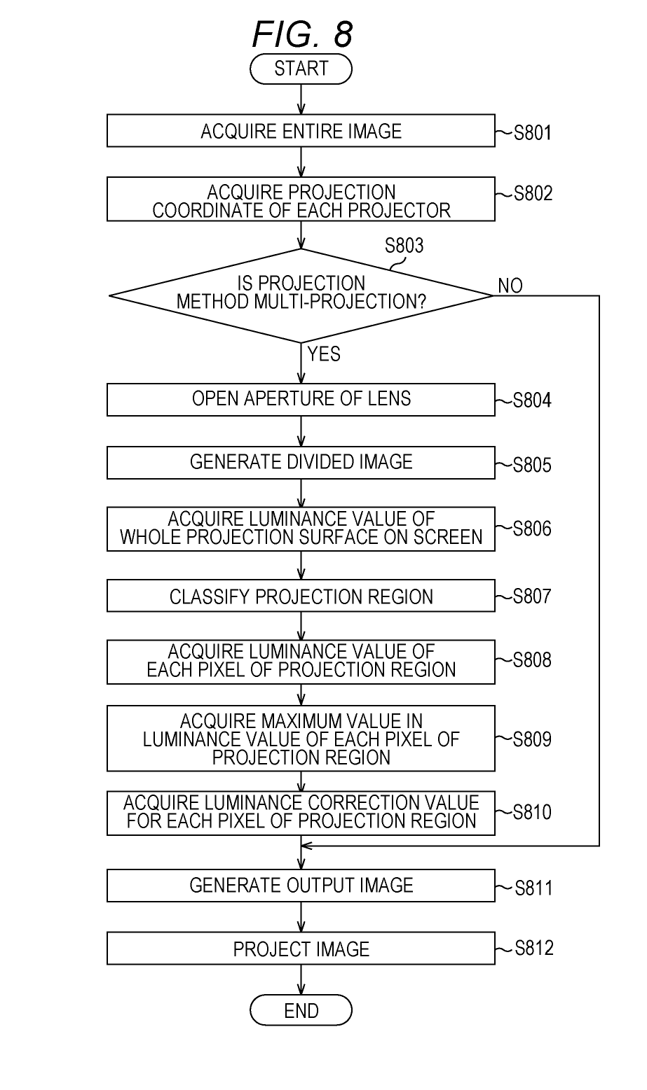

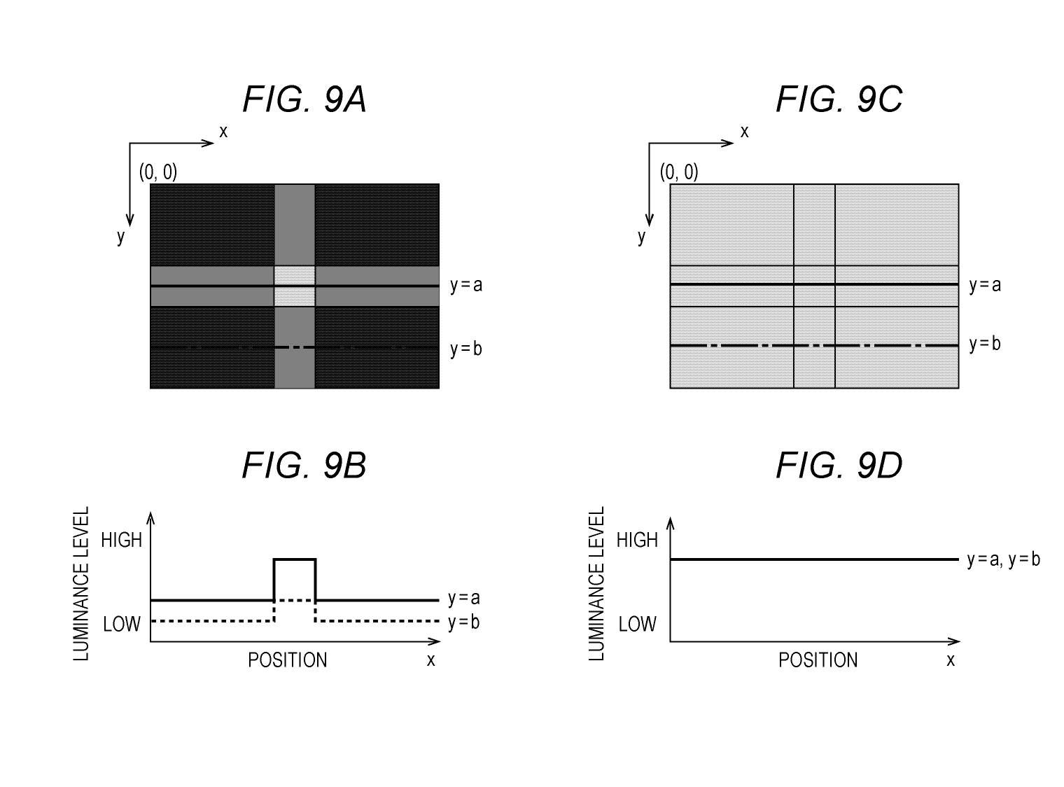

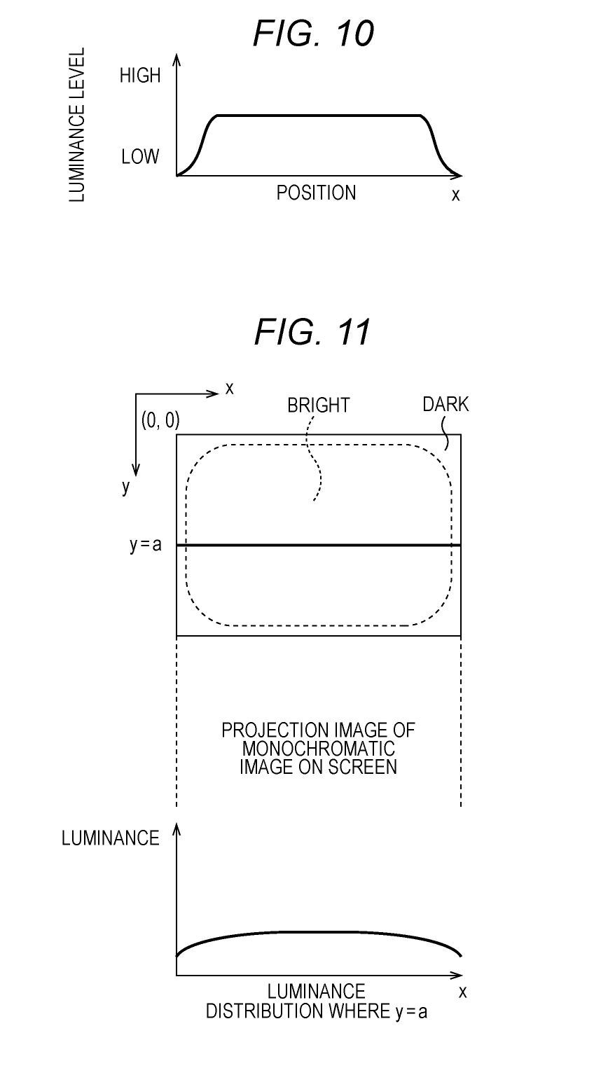

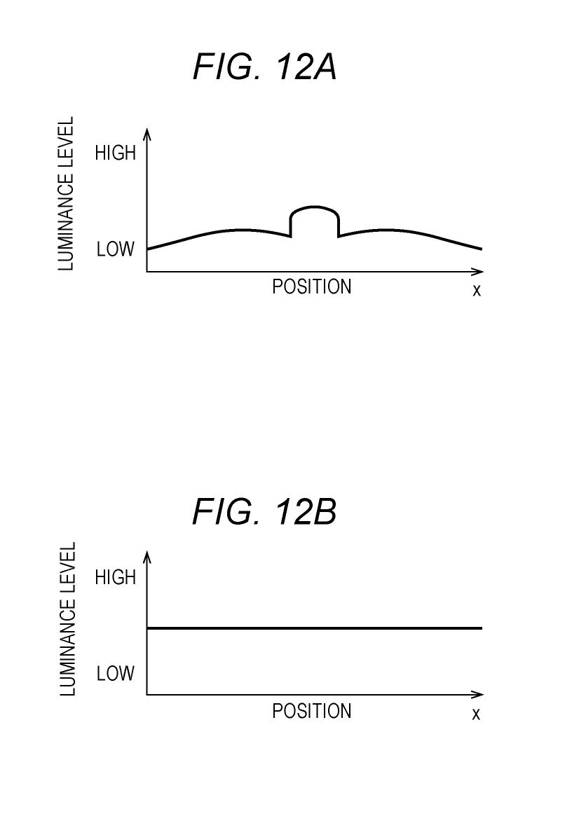

FIG. 8 is a flowchart illustrating an example of a processing procedure of image projection by the multi-projection system according to the present embodiment. Steps S801 and S802 are similar to Steps S601 and S602 in FIG. 6 respectively.

In Step S803, the projection method determining unit 701 determines whether the projection method is multi-projection or single projection, based on the positional information of the projection region of each projector acquired by the projection information setting unit 101. Based on a result of this determination, the flow proceeds to Step S804 when the projection method is multi-projection, and proceeds to Step S811 when the projection method is single projection.

In Step S804, the projection method determining unit 701 sends the control signal to open the aperture of the projection lens to the aperture control unit 702 of the corresponding projector. As a result, the aperture control unit 702 controls the projection unit 211 to open the aperture of the projection lens, and opens the aperture of the projection lens. Since the processing of the next Steps S805 to S810 is similar to that of Steps S603 to S608 in FIG. 6 respectively, the descriptions thereof will be omitted.

Although Step S811 is similar to Step S609 in FIG. 6, when the projection method is single projection, an output image generating unit 105 acquires an image to be projected from an image acquiring unit 100 as it is, and sends the image to a divided image acquiring unit 210 of the corresponding projector.

In Step S812, the divided image acquiring unit 210 acquires a projection image from the image processing device 10 and projects the projection image, which the projection unit 211 has received by the divided image acquiring unit 210, on a screen.

In the present embodiment, when the projection method is single projection, the aperture of the projection lens is narrowed so that decrease in the amount of peripheral brightness reduces. In this case, although the luminance at the center on a projection surface decreases, black floating is not so noticeable since the projection method is single projection. Since the correction of a luminance value is not made as shown in FIG. 8, the reduction of the decrease in the amount of peripheral brightness is given priority. On the other hand, when the projection method is multi-projection, the aperture of the projection lens is opened so that the luminance at the center on the projection surface increases. In this case, the luminance value of an overlapping region decreases since the decrease in the amount of peripheral brightness reduces. As a result, it is possible to reduce the black floating. In addition, it is possible to make the luminance distribution constant by correcting the luminance value. Moreover, it is possible to suppress the deterioration of contrast compared with the related art, since the luminance at the center on the projection surface increases.

According to an embodiment of the present invention, it is possible to reduce the decrease in the amount of peripheral brightness and the black floating without photographing the projection surface by a camera when the image is projected by the multi-projection system.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-237188, filed Nov. 15, 2013, which is hereby incorporated by reference herein in its entirety.

What is claimed is:

1. An image processing device for making a plurality of projectors project an image based on an input image signal such that a part of a projection region overlaps, the image processing device comprising:
an acquiring unit configured to acquire distribution information on distribution of a luminance of a displayed image when the projector projects the image based on an image signal in which a pixel value is constant; and
a generating unit configured to generate an image signal for each projection of the plurality of projectors, by correcting the input image signal by using each distribution information of the plurality of projectors.

2. The image processing device according to claim 1,
wherein the constant pixel value is a pixel value corresponding to a minimum luminance value,
wherein, based on the distribution information and information on overlap of the projection region, the acquiring unit acquires a maximum luminance value of the displayed image when the plurality of projectors projects the image based on the image signal in which the pixel value is constant, and
wherein the generating unit corrects the input image signal such that the minimum luminance value of the input image signal corresponds to the acquired maximum luminance value.

3. The image processing device according to claim 1, further comprising:
a region information acquiring unit configured to acquire region information of each projection region of the plurality of projectors; and
an output unit configured to divide the image signal corrected by the generating unit based on the region information, and to output the image signal to the plurality of projectors.

4. The image processing device according to claim 1, further comprising:
a determining unit configured to determine whether the image based on the input image signal is projected by the plurality of projectors or projected by a single projector; and
an aperture control unit configured to output a control signal to open an aperture of each lens of the plurality of projectors when the determining unit determines that the image is projected by the plurality of projectors.

5. An image processing method for making a plurality of projectors project an image based on an input image signal such that a part of a projection region overlaps, the image processing method comprising:
acquiring distribution information on distribution of a luminance of a displayed image when the projector projects the image based on an image signal in which a pixel value is constant; and
generating an image signal for each projection of the plurality of projectors, by correcting the input image signal by using each distribution information of the plurality of projectors.

6. The image processing method according to claim 5,
wherein the constant pixel value is a pixel value corresponding to a minimum luminance value,
wherein, based on the distribution information and information on overlap of the projection region, acquiring includes acquiring a maximum luminance value of the displayed image when the plurality of projectors projects the image based on the image signal in which the pixel value is constant, and
wherein generating includes correcting the input image signal such that the minimum luminance value of the input image signal corresponds to the acquired maximum luminance value.

7. The image processing method according to claim 5, further comprising:
acquiring region information of each projection region of the plurality of projectors; and
dividing the corrected image signal based on the region information, and outputting the image signal to the plurality of projectors.

8. A non-transitory computer-readable storage medium storing a program to cause an image processing device to perform image processing method for making a plurality of projectors project an image based on an input image signal such that a part of a projection region overlaps, the image processing method comprising:
acquiring distribution information on distribution of a luminance of a displayed image when the projector projects the image based on an image signal in which a pixel value is constant; and
generating an image signal for each projection of the plurality of projectors, by correcting the input image signal by using each distribution information of the plurality of projectors.

9. The non-transitory computer-readable storage medium according to claim 8,
wherein the constant pixel value is a pixel value corresponding to a minimum luminance value,
wherein, based on the distribution information and information on overlap of the projection region, acquiring includes acquiring a maximum luminance value of the displayed image when the plurality of projectors projects the image based on the image signal in which the pixel value is constant, and
wherein generating includes correcting the input image signal such that the minimum luminance value of the input image signal corresponds to the acquired maximum luminance value.

10. The non-transitory computer-readable storage medium according to claim 8, further comprising:
acquiring region information of each projection region of the plurality of projectors; and
dividing the corrected image signal based on the region information, and outputting the image signal to the plurality of projectors.
